(19) United States
(12) Patent Application Publication
(10) Pub. No.: US 2004/0099716 A1
(43) Pub. Date: May 27, 2004

(54) Solder joint reliability by changing solder pad surface from flat to convex shape

(75) Inventors: Yuan Yuan, Austin, TX (US); Burton J. Carpenter, Austin, TX (US)

Correspondence Address: John A. Fortkort, John A. Fortkort P.C., 4512 Court of St. James, Austin, TX, 78730, US

(73) Assignee: Motorola Inc.

(21) Appl. No.: 10/306,626

(22) Filed: Nov. 27, 2002

(51) Int. Cl. B23K 35/12

(52) U.S. Cl. 228/246

(57) ABSTRACT

A device (61) is provided herein which comprises a semiconductor substrate (63) having a solder pad (65) disposed thereon. The solder pad (65) has a convex surface (67) upon which is disposed a solder (75). The solder joints formed with this type of solder pad are found to exhibit reduced stress and improved reliability.

### FIELD OF THE INVENTION

The present invention relates generally to solder joints, and more particularly to solder pad designs which can be used to improve the integrity of solder joints.

### BACKGROUND OF THE INVENTION

Solder joints are used widely throughout the semiconductor art as a convenient means for forming physical and/or electrical connections between device components. Such components may be, for example, a die and an IC packaging substrate, or an IC packaging substrate and a Printed Circuit Board (PCB). Typically, solder joint formation involves the mechanical or electrochemical deposition of solder onto a surface of at least one of the components to be joined together, followed by solder reflow.

FIG. 1 illustrates a typical solder joint 11 formed between first 13 and second 15 device components. The joint comprises a portion of solder 17 that spans between a first solder pad 19 disposed on the first component and a second solder pad 21 disposed on the second component. In the particular device illustrated, the first component is equipped with a solder mask 20 that defines the solder pad and hence the solder joint formed to that component is solder mask-defined (SMD), while the solder joint formed to the second component is non-solder mask-defined (NSMD).

In a typical device, the components joined together by a solder joint, such as a die and a PCB, have differing coefficients of thermal expansion. Consequently, varying amounts of stress and strain are applied to the solder joint as the device undergoes thermal cycling. Over time, these forces can cause the solder joint to crack, which may result in mechanical and/or electrical failure of the joint and/or the device.

The issue of solder joint failure and its effect in shortening the lifetime of semiconductor devices that contain solder joints has been recognized in the art for some time. Consequently, a variety of approaches have been proposed in the art to minimize solder joint failure, and to improve the reliability of semiconductor devices employing solder joints. Most of these approaches are undesirable, however, in that they significantly complicate the manufacturing process.

For example, in some approaches, the gap between two components that are connected together by solder joints is subjected to an underfill operation with an adhesive at some point after solder reflow. In theory, the adhesive reduces the incidence of solder joint failure by relieving some of the stress on the solder joints through the provision of an additional bond between the two components. However, the underfill operation adds significantly to the cost and complexity of the manufacturing process, and makes reworking of the device impractical.

There is thus a need in the art for a simple method for forming solder joints that are more resistant to stress and strain, that exhibit improved lifetimes, and that allow the device to be reworked if the solder joint proves to be defective. There is also a need in the art for devices made in accordance with such a method. These and other needs are met by the present invention, as hereinafter described.

### SUMMARY OF THE INVENTION

In one aspect, a device is provided herein which comprises a first device component having a first solder pad disposed thereon. The first solder pad has a first convex surface. A portion of solder may be disposed on the first convex surface. The device may further comprise a second device component having a second solder pad disposed thereon. The second solder pad may have a second convex surface, and the first and second convex surfaces may be connected by a portion of solder. The first or second device component may be, for example, a die, an integrated circuit, a Printed Circuit Board (PCB), or a packaging substrate. The first solder pad preferably has a normalized solder pad thickness which is typically within the range of about 20 to about 150, preferably within the range of about 60 to about 125, more preferably within the range of about 80 to about 120, and most preferably within the range of about 90 to about 110. The first solder pad may have a first component comprising a first metal and a second component comprising a second metal, and the first and second metals may be distinct.

In another aspect, a method for forming a solder pad is provided. The solder pad may be formed by fabricating a first component of the solder pad comprising a first metal, and forming a second component of the solder pad on the first component, the second component having a convex surface and comprising a second metal diverse from the first metal. The solder pad may comprise one or more of the following metals or their alloys: copper, tungsten, beryllium, aluminum, gold, molybdenum, nickel, tin, silver, and bismuth.

In still another aspect, a method is provided for forming a solder joint. In accordance with the method, a substrate is provided which may be, for example, semiconductor parts such as a die, packaging substrate or PCB. A first component of a solder pad is created on the substrate, said first component comprising a first metal. A second component is created on the first component, the second component having a convex surface and comprising a second metal diverse from the first metal. A portion of solder is then disposed onto the convex surface, and is reflowed.

In still another aspect, a device is provided comprising a solder pad having a convex surface, and having a portion of solder joined to the solder pad across the convex surface. The solder pad preferably has a normalized solder pad thickness within the range of about 20 to about 150, more preferably within the range of about 60 to about 125, and most preferably within the range of about 90 to about 110.

These and other aspects of the present invention are described in further detail below.

### DESCRIPTION OF THE FIGURES

FIG. 1 is an illustration of a prior art solder joint;

FIGS. 2-4 are illustrations of solder pads in accordance with the teachings herein;

FIG. 5 is an illustration showing the distribution of strain in a prior art solder joint;

FIG. 6 is an illustration showing the distribution of strain in a solder joint made in accordance with the teachings herein;

FIGS. 7-9 are illustrations of a two-part solder pad made in accordance with the teachings herein;

FIG. 10 is a graph of stress as a function of strain for eutectic Sn—Pb solder;

FIG. 11 is a graph of elastic modulus as a function of strain for various materials;

FIG. 12 is a plot of Von Mises strain in the convex portion of a two-part solder joint made in accordance with the teachings herein and using various other materials in the second portion of the solder pad; and

FIGS. 13-14 are cross-sectional illustrations of particular embodiments of solder pads made in accordance with the teachings herein;

FIG. 15 is a perspective view, partially in section, of a particular embodiment of a solder pad made in accordance with the teachings herein;

FIG. 16 is a cross-sectional illustration of a particular embodiment of a solder pad made in accordance with the teachings herein;

FIG. 17 is a graph of von Mises strain as a function of normalized solder pad thickness; and

FIG. 18 is an illustration of the curvature of solder pads for the cases where tₙ=100 and where tₙ is less than 100.

### DETAILED DESCRIPTION

As used herein, the term “normalized solder pad thickness” (tₙ), when used in reference to a solder pad disposed on a bond pad (and wherein the bond pad is itself disposed on a surface), refers to the ratio

tₙ=100w/k (EQUATION 1)

where w is the maximum dimension of the solder pad in the direction perpendicular to the surface, and k is the largest dimension of the bond pad in a direction parallel to the surface. FIG. 18 illustrates this definition for the case where tₙ=100 (lower curve; solder pad is a perfect hemisphere) and for the case where tₙ is some value less than 100 (upper curve; solder pad is aspherical).

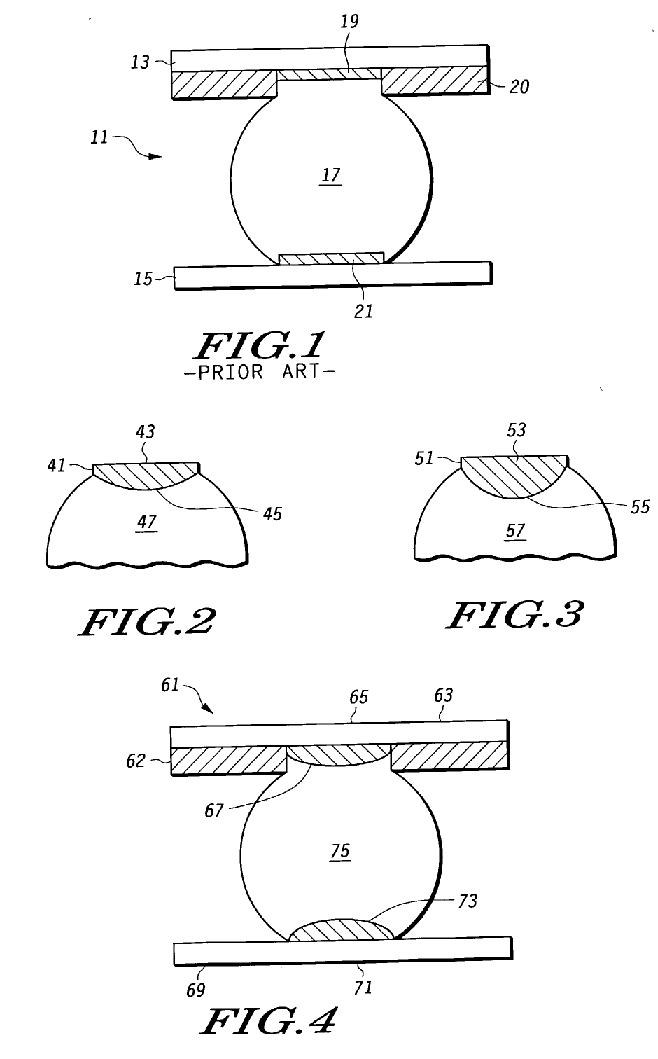

It has now been found that, by utilizing a convex solder pad (see, for example, FIGS. 2-4 and FIGS. 7-9) in the formation of a solder joint, the lifetime of the solder joint can be significantly improved compared to the lifetime of a solder joint formed on a conventional flat solder pad. Without wishing to be bound by theory, the improvement in solder joint lifetime is believed to be due in part to the larger surface area of the solder/solder bond pad interface provided by a convex solder pad as compared to that provided by a conventional flat solder pad (such as the prior art solder pad depicted in FIG. 1) having the same diameter. As a result of this larger interface, shear forces are spread out over a larger area so that the shear force at any point on the interface is diminished. Moreover, the convex solder pads described herein penetrate more deeply into the solder ball, thus facilitating a more direct transfer of shear forces into the solder joint. More importantly, the convex shape solder pad avoids stress concentration at the corner of the solder to pad interface.

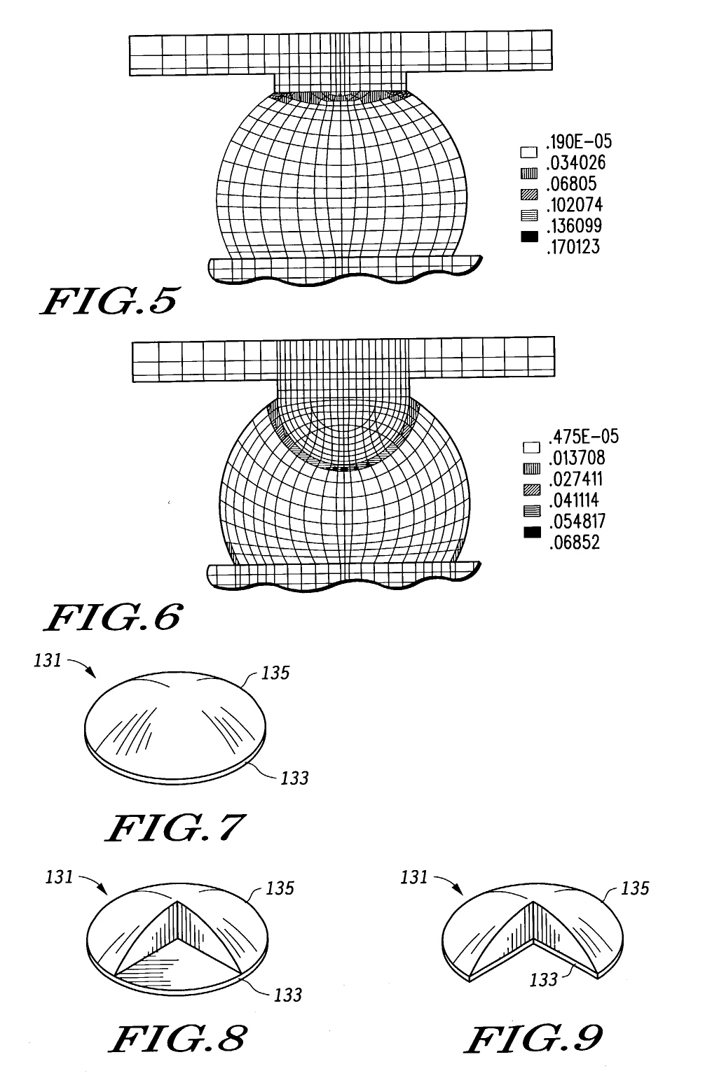

The convex solder pads made in accordance with the teachings herein may be of a unitary or single-component structure, as in the embodiments depicted in FIGS. 2-4, or may have a multi-component construction, as in the embodiments depicted in FIGS. 7-9. These embodiments are described in greater detail below.

FIGS. 2-4 illustrate some particular embodiments of unitary convex solder pads made in accordance with the teachings herein. In the embodiment shown in FIG. 2, the solder pad 41 has a first surface 43 which abuts the substrate (not shown) or surface that the solder pad is disposed upon, and a second, convex surface 45 which is in contact with the solder 47. The solder pad 51 depicted in FIG. 3 also has a first surface 53 which abuts the substrate (not shown) or surface that the solder pad is disposed upon, and a second, convex surface 55 which is in contact with the solder 57. However, the solder pad depicted in FIG. 3 differs from that of FIG. 2 primarily in that the curvature of the second surface 55 of the solder pad 51 depicted in FIG. 3 is greater than the curvature of the second surface 45 of the solder pad depicted in FIG. 2. Consequently, other things being equal, the normalized solder pad thickness (tₙ) of the embodiment of FIG. 3 is greater than the normalized solder pad thickness of the embodiment of FIG. 2.

FIG. 4 depicts a device made by utilizing single-component solder pads of the type illustrated in FIGS. 2-3. As shown in FIG. 4, the device 61 comprises a first component 63 equipped with a first bond pad 65 and having a first solder pad 67 disposed on the first bond pad. The device further includes a second component 69 equipped with a second bond pad 71 and having a second solder pad 73 disposed on the second bond pad. The first and second bond pads are connected via a solder joint 75. In the particular device illustrated, the first substrate is equipped with a solder mask 62 which helps define the shape of the solder pad and hence the solder joint formed to that substrate is solder mask-defined (SMD), while the solder joint formed to the second substrate is non-solder mask-defined (NSMD).

In the device shown in FIG. 4, both of the first and second solder pads are of the type disclosed herein. It will be appreciated, however, that even if only one of the first or second solder pads were of the type disclosed herein, there would still be some improvement in solder joint reliability. It will likewise be appreciated that the first and second solder pads could have the same or different curvature or normalized solder pad thickness, and could be made of the same or different materials. One or both of the solder pads could also have a two-component structure as described below.

FIG. 5 illustrates the results of a finite element modeling analysis of strain in a solder joint incorporating a conventional flat solder pad. The software used in the analysis was the ANSYS® Finite Element Method software, available commercially from Ansys Inc., Canonsburg, Pa. As the results of that analysis indicate, von Mises strain, which arises predominantly from shear deformation between parts connected by the solder joint, is localized along the solder/solder pad interface, and reaches a maximum of about 0.17 (strain is unitless) in the solder adjacent to the edges of the solder pad.

FIG. 6 illustrates the results of the modeling analysis of FIG. 5 applied to a solder joint formed using a convex solder pad of the type depicted in FIGS. 2-3. For the purposes of the analysis, the diameter of the solder pad in FIG. 6 (in the direction parallel to the substrate) was assumed to be the same as the solder pad of FIG. 5. As shown in FIG. 6, the use of a convex solder pad in accordance with the teachings herein has distinct advantages. First of all, the maximum von Mises strain in the solder joint of FIG. 6 is substantially reduced compared to the solder joint of FIG. 5. In addition, in the solder joint of FIG. 5, the strain is maximized along the edges of the solder pad. However, in the solder joint of FIG. 6, the strain is maximized near the center of the solder pad as a result of the convex shape of the solder pad. This has the effect of shifting the maximum strain toward the center of the solder joint where the joint is thickest and thus best adapted to accommodate shear strain. By contrast, in FIG. 5, the maximum strain occurs at the thinnest part of the solder joint. Moreover, the maximum strain in FIG. 6 (about 0.08) is substantially lower (by about 60%) than the maximum strain in FIG. 5 (about 0.12).

The effect of normalized solder pad thickness on strain is depicted in FIG. 17. As shown therein, maximum strain decreases as normalized solder pad thickness (tₙ) increases. The effect is small for values of tₙ below 10, but is more pronounced for values of tₙ within the range 10<tₙ<30. Strain continues to decline as the thickness of the solder pad approaches the radius of the bond pad (that is, as the normalized solder pad thickness approaches 100). Indeed, though it is not shown in the graph, the effect continues as the thickness of the solder pad exceeds the radius of the bond pad (that is, as the normalized solder pad thickness exceeds 100).

The value of tₙ in the various embodiments of solder pads depicted herein may vary, and the optimum value of tₙ may be driven by a variety of design considerations. However, tₙ is typically within the range of about 30 to about 150, preferably within the range of about 60 to about 125, more preferably within the range of about 80 to about 120, and most preferably within the range of about 90 to about 110.

FIGS. 7-9 illustrate one possible embodiment of a multi-component (in this case, a two-component) solder pad made in accordance with the teachings herein. The solder pad 131 comprises a first portion 133 and a second portion 135. FIG. 7 is a perspective view of the entire solder pad, while FIGS. 8 and 9 depict the solder pad with a section of the second 135 and first 133 portions of the solder pad removed, respectively, to reveal the construction of the solder pad. In the particular embodiment depicted, the first portion has a first major surface which is bonded to a substrate or surface (not shown) and a second major surface upon which the second portion of the solder pad is disposed. However, variations of this embodiment are also possible in which one or both major surfaces of the first portion are not flat. For example, the first portion may have a first surface that is flat and a second surface which is convex or concave.

The first portion of the solder pad preferably has a circular shape when viewed in a direction perpendicular to its surface, although variations are possible in which the first portion of the solder pad has other shapes. Such other shapes include, for example, rectangles, squares, pentagons, hexagons, and other polygons, ellipses, irregular shapes, and various combinations of the foregoing.

The second portion of the solder pad preferably comprises a first major surface that is coextensive with the second major surface of the first portion of the solder pad, and a second major surface that is essentially convex. The first major surface of the second portion of the solder pad is preferably identical in shape and size to the second major surface of the first portion of the solder pad—that is, the first portion of the solder pad preferably transitions smoothly into the second portion of the solder pad. However, embodiments are also possible wherein the transition is discontinuous. This could be the case, for example, if the first and second portions of the solder pad are fabricated separately and later stacked.

The first and second portions of the solder pad may comprise first and second materials, respectively. The first and second materials may be the same or diverse. If the first and second materials are diverse, the solder pad will typically be formed through a process in which the first and second portions of the solder pad are formed in separate steps of a multi-step process. The first and second portions of the solder pad may comprise various materials. These include, for example, copper, tungsten, beryllium, aluminum, bismuth, gold, silver, nickel, tin, molybdenum, or various alloys based on one or more of the foregoing metals. Materials which are especially suitable for use in the second portion of the solder pad include, for example, high melting point solders, molybdenum, nickel, aluminum, copper, and other metal alloys that bond well with both the first portion of the solder pad and with solders.

When the first 133 and second 135 portions of the solder pad comprise first and second diverse materials, respectively, then the second material preferably possesses a higher Young's modulus than the solder material. This serves to reduce solder strain, especially at high solder strain deformation. It is also preferred that the second material has a higher melting temperature relative to the solder material. Thus, if T₂ is the melting temperature of the solder material (or highest melting temperature, if the solder material melts over a range), and T₁ is the melting temperature of the second material (or the lowest melting temperature, if the second material melts over a range), then T₁-T₂ is typically at least about 25° C., preferably at least about 50° C., more preferably at least about 75° C., and most preferably at least about 100° C. The possession of these two properties (melting temperature and modulus) allows the second portion of the solder pad to perform essentially the same function as a convex solder pad made entirely of one material.

One advantage offered by two-component solder pads of the type disclosed herein is that the components can be fabricated in separate steps or by separate processes. This is particularly helpful when one of the materials used in the solder pad is of a type that cannot be readily formed into a convex surface. In such a case, that material may be used to form a first component of the solder pad (which may be achieved, for example, through a conventional plating process), and a different material, can be placed upon the first portion and reflowed to form a second portion of the solder pad having the requisite convex surface. Alternately, the second material could be plated on the first material. Hence, the multi-component structure allows the use of materials in the solder pad that might be infeasible to use in the formation of a unitary solder pad having a convex surface.

In the single-component and multi-component solder pads disclosed herein, it is preferred that the solder pads exhibit a sufficiently high elastic modulus relative to the solder so that the solder pad will carry the mechanical load directly and deeply into the solder joint. However, this requirement can be relaxed. Because solder exhibits very low modulus at large strain, and large strain is the critical case for solder, consequently, the difference in elastic modulus between the solder pad and the solder need be large only at higher solder strain conditions.

This consideration is illustrated in FIGS. 10 and 11. FIG. 10 depicts stress as a function of strain for a eutectic solder. As seen from that figure (and keeping in mind that elastic modulus is a function of strain), the elastic modulus of the eutectic solder reduces rapidly as strain increases. This result is seen again in FIG. 11. As shown therein, the elastic modulus of the eutectic solder, though initially a little above 6000 MPa, drops off rapidly as strain increases. By contrast, however, the elastic moduli of medium-stiffness materials such as copper, nickel and the “other material” remain essentially constant as a function of strain within a practically applicable strain range (here, the “other material” is a hypothetical material whose modulus was chosen for illustration purposes). Hence, these materials may be used effectively as solder pad materials because they remain stiff relative to the solder as the solder joint is undergoing large strain (that is, at conditions approaching critical strain). It will thus be appreciated that, so long as the material of the solder pad remains substantially stiffer, as strain increases, than the solder, materials of a wide range of elastic modulus can be used in the solder pad. Preferably, the elastic modulus E₂ of the solder pad material and the elastic modulus E₁ of the solder at a strain of 0.02 are such that E₂-E₁ is typically at least about 30,000 MPa, preferably at least about 55,000 MPa, more preferably at least about 70,000 MPa, and most preferably at least about 100,000 MPa.

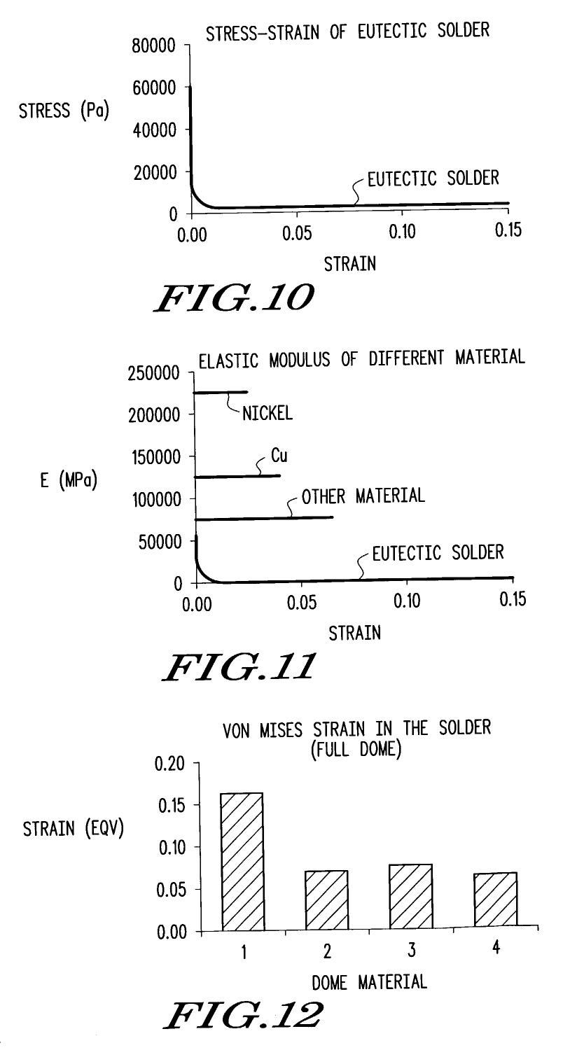

FIG. 12 is a graph of the von Mises strain in the solder joint when various materials are used in the solder pad. The von Mises strain is the strain arising from distortion of the solder joint. Materials 2, 3 and 4 of FIG. 12 are unitary convex solder pads comprising copper, nickel, and a hypothetical material having an elastic modulus of 75 GPa, respectively. Material 1 is a control sample, and represents a conventional flat solder pad comprising copper. As seen from FIG. 12, the strain existing in the control sample based on a flat solder pad is about twice as large as the strain present when any of materials 2, 3 or 4 are used in a convex solder pad, thus demonstrating the reduction in strain in a solder joint incorporating the solder pads made in accordance with the teachings herein.

The solder pads made in accordance with the teachings herein have been described primarily with reference to single-component and two-component systems. However, it will be appreciated that solder pads made in accordance with the teachings herein are not limited to one- or two-component systems, but include multi-component systems in general, which may have more than two components. An example of the later would be a three component system, where the materials of a first and second components do not adhere to each other well and wherein a third component, in the form of a layer disposed between the first and second components, is used to facilitate adhesion between the other two components. Typically, practical considerations will limit the number of components to no more than a few in most applications. The surface between components may be flat, convex, concave or any other shape as long as the composed outer surface is in convex shape.

Moreover, while many of the embodiments described herein have been depicted with convex surfaces that are smooth, one skilled in the art will appreciate that embodiments may also be made in accordance with the teachings herein in which the convex surface of the solder pad is not smooth. One example of this type of embodiment is illustrated in FIG. 13. There, the outer surface 153 of the solder pad 151 is roughened. Such a roughened surface may result inherently from the process used to create the solder pad, or may be an artifact of an etching step or other treatment used to prepare the solder pad for application of the solder. For comparative purposes, surface 155 is included in the illustration to show the approximation of the surface to a smooth convex surface. Without wishing to be bound by theory, it is believed that a roughened surface of the type depicted in FIG. 13 may, in some cases, further reduce the strain at the solder/solder pad interface by increasing the surface area of the interface as compared to the smooth convex surface depicted by surface 155.

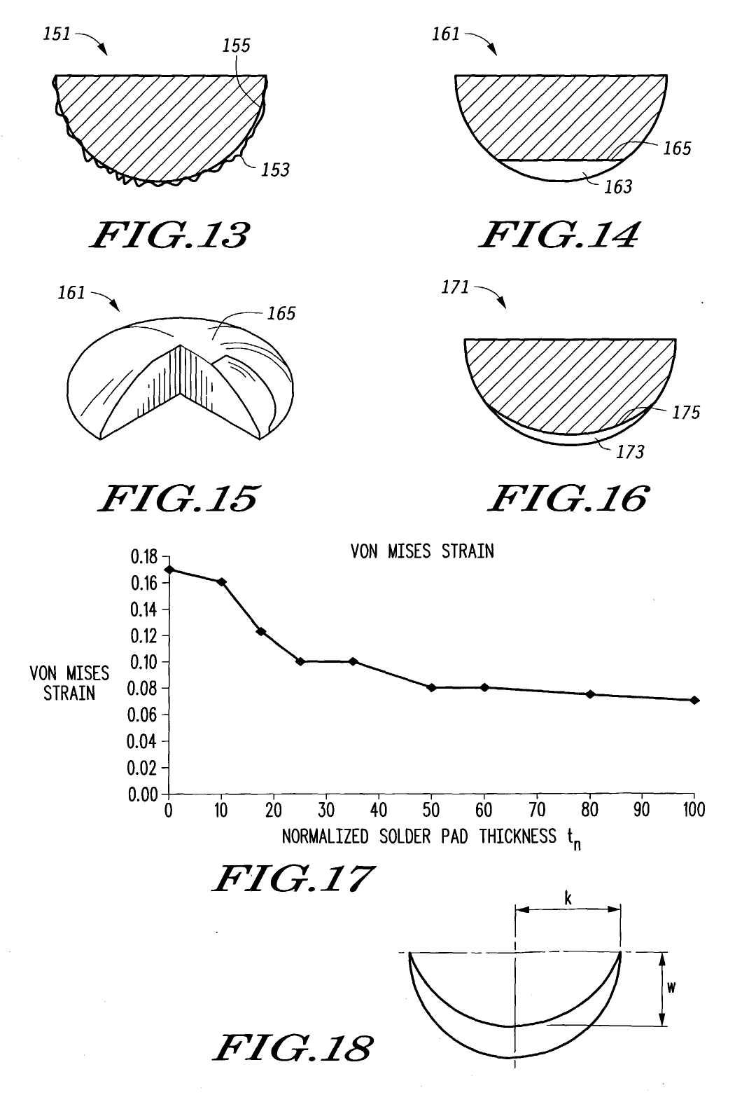

FIGS. 14-16 illustrate some further variations possible with solder pads made in accordance with the teachings herein. The solder pad 161 of FIGS. 14 and 15 is similar to the solder pad depicted in FIG. 3, except that a portion 163 of the solder pad of FIG. 14 has been removed or flattened so that the solder pad terminates in a flattened surface 165.

In the solder pad 171 of FIG. 16, the solder pad has a first portion which is described by a first curved surface 173, and a second portion which is described by a second curved surface 175. The actual solder pad is illustrated by cross-hatching. Hence, the actual surface of the solder pad is described by a combination of curves, rather than a single curve. For example, the solder pad may have a surface such that the first curved surface is essentially spherical, and the second curved surface is aspherical or is also spherical but has a different radius of curvature than the first curved surface.

A convex solder pad has been provided herein which significantly reduces the strain in a solder joint incorporating the pad, and which thereby improves the reliability of the solder joint. The solder pad may be a unitary structure, or a multi-component structure in which the separate components may comprise diverse materials.

The above description of the invention is illustrative, and is not intended to be limiting. It will thus be appreciated that various additions, substitutions and modifications may be made to the above described embodiments without departing from the scope of the present invention. Accordingly, the scope of the present invention should be construed solely in reference to the appended claims.

What is claimed is:

1. A device, comprising:
a first device component having a first solder pad disposed thereon, said first solder pad having a first convex surface; and
a portion of solder disposed on said first convex surface.

2. The device of claim 1, further comprising a second device component having a second solder pad disposed thereon, said second solder pad having a second surface, and wherein said first and second surfaces are connected by the portion of solder.

3. The device of claim 2, wherein said first and second device components are selected from the group consisting of die, packages, packaging substrates, and PCBs.

4. The device of claim 3, wherein said second surface is also convex.

5. The device of claim 1, wherein said first solder pad has a normalized solder pad thickness within the range of about 20 to about 150.

6. The device of claim 1, wherein said first solder pad has a normalized solder pad thickness within the range of about 60 to about 125.

7. The device of claim 1, wherein said first solder pad has a normalized solder pad thickness within the range of about 90 to about 110.

8. The device of claim 1, wherein the first solder pad has a first portion comprising a first metal and a second portion comprising a second metal, and wherein said first and second metals are diverse.

9. The device of claim 8, wherein said second portion is in contact with the solder, and wherein said second metal has a higher Young's modulus than the solder.

10. The device of claim 9, wherein T₂ is the highest melting temperature of the solder, wherein T₁ is the lowest melting temperature of the second metal, and wherein T₁- T₂ is at least about 25° C.

11. The device of claim 10, wherein T₁- T₂ is at least about 50° C.

12. The device of claim 1, wherein the elastic modulus E₁ of the solder pad material and the elastic modulus E₂ of the solder at a strain of 0.02 are such that E₁-E₂ is at least about 30,000 MPa.

13. The device of claim 1, wherein the elastic modulus E₁ of the solder pad material and the elastic modulus E₂ of the solder at a strain of 0.02 are such that E₁-E₂ is at least about 55,000 MPa.

14. The device of claim 1, wherein the elastic modulus E₁ of the solder pad material and the elastic modulus E₂ of the solder at a strain of 0.02 are such that E₁-E₂ is at least about 70,000 MPa.

15. A method for forming a solder joint, comprising the steps of:
providing a solder pad having a convex surface; and
disposing a portion of solder onto said convex surface.

16. The method of claim 15, wherein the step of providing a solder pad having a convex surface comprises the steps of providing a first portion of a solder pad comprising a first metal, and forming a second portion of a solder pad on the first portion, said second portion having a convex surface and comprising a second metal diverse from the first metal.

17. The method of claim 16, wherein the first portion of the solder pad has a flat surface.

18. The device of claim 15, wherein said solder pad has a normalized solder pad thickness within the range of about 20 to about 150.

19. The device of claim 15, wherein said solder pad has a normalized solder pad thickness within the range of about 60 to about 125.

20. The device of claim 15, wherein said solder pad has a normalized solder pad thickness within the range of about 90 to about 110.

21. A method for forming a solder joint, comprising the steps of:
providing a substrate;
creating a first portion of a solder pad on the substrate, said first portion comprising a first metal;
creating a second portion of a solder pad on the first portion, said second portion having a convex surface and comprising a second metal distinct from the first metal;
disposing a portion of solder onto said convex surface; and
reflowing the solder.

22. The method of claim 21, wherein the first portion of the solder pad has a flat surface.

23. The device of claim 21, wherein said solder pad has a normalized solder pad thickness within the range of about 20 to about 150.

24. The device of claim 21, wherein said solder pad has a normalized solder pad thickness within the range of about 60 to about 125.

25. The device of claim 21, wherein said solder pad has a normalized solder pad thickness within the range of about 90 to about 110.

26. A device, comprising:
a solder pad having a convex surface; and
a portion of solder joined to said solder pad across said convex surface.

27. The device of claim 26, wherein said solder pad has a normalized solder pad thickness within the range of about 20 to about 150.

28. The device of claim 26, wherein said solder pad has a normalized solder pad thickness within the range of about 60 to about 125.

29. The device of claim 26, wherein said solder pad has a normalized solder pad thickness within the range of about 90 to about 110.
